(19) United States
(12) Patent Application Publication
(10) Pub. No.: US 2014/0095999 A1
(43) Pub. Date: Apr. 3, 2014

(54) SEARCH AND PARENTAL CONTROL FEATURES FOR DIGITAL ENTERTAINMENT SERVICES

(71) Applicant: Target Brands, Inc., Minneapolis, MN (US)

(72) Inventors: Daniel J. Lehto, Eden Prairie, MN (US); Todd A. Hagen, Shakopee, MN (US); Gregory M. Nations, Minneapolis, MN (US); Ryan M. Damian, Brooklyn, NY (US)

(21) Appl. No.: 14/039,797

(22) Filed: Sep. 27, 2013

Related U.S. Application Data
(60) Provisional application No. 61/707,583, filed on Sep. 28, 2012.

(51) Int. Cl. G06F 3/0482

(52) U.S. Cl. CPC G06F 3/0482
USPC 715/716

(57) ABSTRACT

A computing device displays a sentence template that includes fixed text and one or more menu boxes. The computing device displays particular menu items associated with the menu boxes in the menu boxes in response to receiving user input to select the particular menu items. The fixed text and the particular menu items form a complete sentence in a human language. Subsequently, the computing device displays graphical elements that identify media assets that satisfy criteria indicated by the complete sentence. A user may then play back one or more of the identified media assets.

This application claims the benefit of U.S. Provisional Application No. 61/707,583, filed Sep. 28, 2012, which is incorporated herein by reference in its entirety.

### BACKGROUND

Consumers are increasingly using digital entertainment services to access (e.g., view and/or listen to) media assets, such as movies, music, and television programs. Such digital entertainment services may allow consumers to download media assets via the Internet. Downloading media assets via the Internet may be more convenient to some consumers than conventional ways of accessing media assets. For instance, downloading a media asset via the Internet may be more convenient to some consumers than traveling to a physical retail store to rent or purchase a physical disc that stores a media asset, or waiting for the media asset to be presented by a television or radio channel.

### SUMMARY

In one example, a method includes displaying, by a computing device, a sentence template that includes fixed text and one or more menu boxes, each of the menu boxes being associated with a different plurality of menu items, displaying, by the computing device, particular menu items associated with the menu boxes in response to receiving user input to select the particular menu items, wherein the fixed text and the particular menu items form a complete sentence in a human language, and displaying, by the computing device, graphical elements that identify media assets that satisfy criteria indicated by the complete sentence.

In another example, a computing device includes one or more processors that are configured to: display a sentence template that includes fixed text and one or more menu boxes, each of the menu boxes being associated with a different plurality of menu items; receive user input to select particular menu items associated with the menu boxes; display the particular menu items in the menu boxes in response to receiving user input to select the particular menu items, in which a complete sentence in a human language is formed by the fixed text and the particular menu items; and display graphical elements that identify media assets that satisfy criteria indicated by the complete sentence. In another example, a computer-readable storage medium stores instructions that, when executed by one or more processors of a computing device, configure the computing device to: display a search interface that includes a sentence template, the sentence template including fixed text interspersed by one or more menu boxes, each of the menu boxes being associated with a different plurality of menu items; display selected menu items in the one or more menu boxes, the selected menu items being selected from the pluralities of menu items associated with the one or more menu boxes, in which the fixed text and the selected menu items form a complete sentence in a human language; and display graphical elements that identify a set of one or more digital media assets, one or more digital media assets satisfying criteria indicated by the complete sentence.

In another example, a method includes displaying, by a computing device, a first user interface of a digital entertainment service, the first user interface including graphical elements that identify digital media assets associated with a first sub-account associated with an account, displaying, by the computing device and in response to receiving a user input to log in a second sub-account associated with the account, a prompt to enter a passcode associated with the second sub-account, and displaying, by the computing device and in response to receiving a user input of the passcode associated with the second sub-account, a second user interface of the digital entertainment service, the second user interface including graphical elements that identify digital media assets associated with the second sub-account.

In another example, a computing device includes one or more processors configured to: display a first user interface of a digital entertainment service, the first user interface associated with a first sub-account of an account, the first user interface including graphical elements that identify digital media assets in a media library associated with the first sub-account; receive user input to log in to a second sub-account of the account; display, in response to receiving the user input to log in to the second sub-account, a prompt to enter a passcode associated with the second sub-account; and display, in response to receiving a user input of the passcode associated with the second sub-account, a second user interface of the digital entertainment service, the second user interface including graphical elements that identify digital media assets in a media library associated with the second sub-account.

In another example, a computer-readable storage medium stores instructions that, when executed by one or more processors of a computing device, configure the computing device to: display a first user interface, the first user interface identifying digital media assets associated with a first sub-account of an account; display, in response to receiving a user input to log in to a second sub-account of the account, a prompt to enter a passcode associated with the second user; and display, in response to receiving user input of the passcode associated with the second sub-account, a second user interface, the second user interface identifying digital media assets associated with the second sub-account.

In another example, a method includes displaying, by a computing device, a user interface of a digital entertainment service, the user interface including, for each sub-account in a plurality of sub-accounts associated with an account, graphical elements for setting access restrictions associated with the sub-account, the access restrictions for the sub-account indicating types of media assets that are allowed to be included in a media library associated with the sub-account.

In another example, a computing device includes one or more processors configured to display a user interface of a digital entertainment service, the user interface including graphical elements for setting access restrictions associated with each sub-account of an accounts, the access restrictions for the sub-accounts indicating types of media assets that are allowed to be included in media libraries associated with the sub-accounts.

In another example, a computer-readable storage medium stores instructions that, when executed by one or more processors of a computing device, cause the computing device to display a user interface of a digital entertainment service, the user interface including graphical elements for each sub-account in a plurality of sub-accounts associated with an account, wherein for each of the sub-accounts, the graphical elements for the sub-account enable a user to set access restrictions associated with the sub-account, the access restrictions for the sub-account indicating types of media assets that are allowed to be included in a media library associated with the sub-account.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a conceptual diagram that illustrates an example environment in which one or more techniques of this disclosure may be implemented.

FIG. 2A is a conceptual diagram that illustrates an example search interface, in accordance with one or more techniques of this disclosure.

FIG. 2B is a conceptual diagram that illustrates another example search interface, in accordance with one or more techniques of this disclosure.

FIG. 3 is a flowchart that illustrates an example operation for searching for media assets, in accordance with one or more techniques of this disclosure.

FIG. 4 is a conceptual diagram that illustrates an example asset group interface, in accordance with one or more techniques of this disclosure.

FIG. 5 is a conceptual diagram that illustrates an example account configuration, in accordance with one or more techniques of this disclosure.

FIG. 6 is a conceptual diagram that illustrates an example sub-account configuration interface, in accordance with one or more techniques of this disclosure.

FIG. 7 is a conceptual diagram that illustrates an example media selection interface, in accordance with one or more techniques of this disclosure.

FIG. 8 is a conceptual diagram that illustrates the example media selection interface of FIG. 7 with an expanded sub-account selection menu, in accordance with one or more techniques of this disclosure.

FIG. 9 is a conceptual diagram that illustrates the example media selection interface of FIG. 8 with a personal identification number (PIN) entry window, in accordance with one or more techniques of this disclosure.

FIG. 10 is a flowchart that illustrates an example operation for changing sub-accounts, in accordance with one or more techniques of this disclosure.

FIG. 11 is a conceptual diagram that illustrates an example sub-account configuration interface, in accordance with one or more techniques of this disclosure.

FIG. 12 is a conceptual diagram that illustrates an example sub-account configuration interface, in accordance with one or more techniques of this disclosure.

FIG. 13 is a conceptual diagram that illustrates an example sub-account configuration interface, in accordance with one or more techniques of this disclosure.

FIG. 14 is a conceptual diagram that illustrates an example sub-account configuration interface, in accordance with one or more techniques of this disclosure.

FIG. 15 is a conceptual diagram that illustrates an example sub-account configuration interface, in accordance with one or more techniques of this disclosure.

FIG. 16 is a conceptual diagram that illustrates an example ratings glossary interface, in accordance with one or more techniques of this disclosure.

FIG. 17 is a conceptual diagram that illustrates an example sub-account configuration interface, in accordance with one or more techniques of this disclosure.

FIG. 18 is a conceptual diagram that illustrates an example sub-account configuration interface, in accordance with one or more techniques of this disclosure.

FIG. 19 is a conceptual diagram that illustrates an example media viewing interface that includes a product recommendation, in accordance with one or more techniques of this disclosure.

FIG. 20 is a flow chart illustrating an example process by which a digital media service may provide product recommendations, in accordance with one or more techniques of this disclosure.

### DETAILED DESCRIPTION

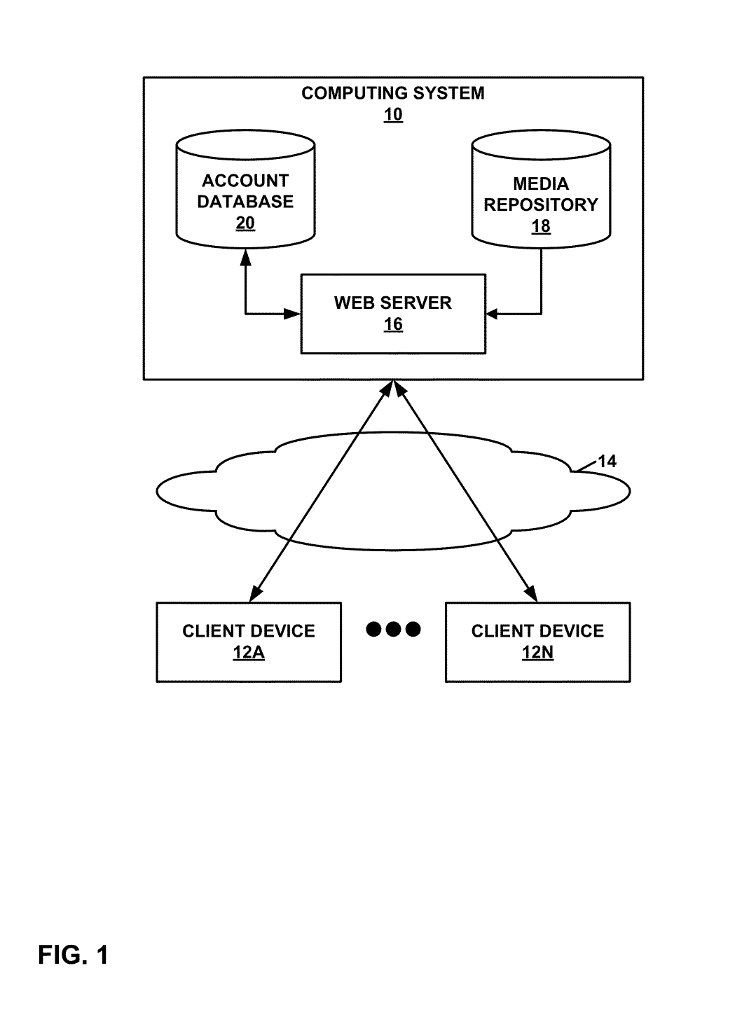

FIG. 1 is a conceptual diagram that illustrates an example environment in which one or more aspects of this disclosure may be implemented. In the example of FIG. 1, a computing system 10 communicates with a plurality of client devices 12A-12N (collectively, “client devices 12”) via a communications network 14. In other examples, other environments may include more, fewer, or different devices, systems, and/or components. Computing system 10 is configured to deliver digital entertainment services to users via client devices 12 by communicating, among other content, various types of digital media assets including movies and television programs. For example, computing system 10 may be configured to stream digital movies, television programs, and other media assets in real or near real-time to client devices 12.

Computing system 10 may comprise one or more computing devices. For example, computing system 10 may comprise one or more standalone server computers, blade server computers, mainframe computers, and/or other types of computing devices. In examples where computing system 10 comprises multiple computing devices, such computing devices may be concentrated at a single physical facility or may be dispersed among multiple physical facilities. In some examples, computing system 10 may be referred to herein as a server system. Each of client devices 12 may comprise one or more computing devices. For example, each of client devices 12 may comprise a desktop computer, a laptop computer, a tablet computer, a television set top box, a network-enabled television, a video game console, a mobile telephone (e.g., a smartphone), or another type of computing device. In one example, client devices 12 can include an appliance type computing device specifically configured for communicating with and receiving digital media entertainment content from computing system 10.

Communication network 14 may comprise various types of networks that enable computing devices to communicate with one another. For example, communication network 14 may comprise a wide area network, such as the Internet. Furthermore, in some examples, communication network 14 may comprise a local area network. Communication network 14 may include wired and/or wireless communication links. For instance, communication network 14 may include a cellular data network and/or a Wi-Fi network.

As noted above, computing system 10 may provide a digital entertainment service. The digital entertainment service may enable users of client devices 12 to purchase and/or rent media assets for playback at client devices 12. Example types of media assets may include movies, television programs, recorded or live music, video clips, live video, and/or other types of pre-recorded or live media.

Computing system 10 may implement the digital entertainment service in various ways. In the example of FIG. 1, the digital entertainment service is implemented, at least in part, using a web server 16. Web server 16 may be implemented on one or more computing devices of computing system 10. Web server 16 may provide data via communication network 14 to client devices 12 in response to requests sent via communication network 14 by client devices 12. Such requests may conform to various communication protocols, such as Hypertext Transfer Protocol (HTTP), Realtime Streaming Protocol (RSTP), Session Initiation Protocol (SIP), and so on.

Web server 16 may transmit media data to client devices 12 in response to requests for the media data from client devices 12. Client devices 12 may process (e.g., decode) and present the media data to users of client devices 12. For instance, client devices 12 may play back movies, television programs, or other types of media to users of respective ones of client devices 12.

In some examples, web server 16 may transmit media data to client devices 12 by streaming the content to client devices 12. For instance, web server 16 may, upon request from one or more of client devices 12, transmit media data to a client device over time as the client device is playing back the media data. In other examples, web server 16 may transmit media data to client devices 12 on a non-streaming basis. For instance, web server 16 may transmit media data to a client device that locally stores the media data for subsequent playback. Computing system 10 may be associated with (e.g., include or otherwise have access to) media repository 18. Media repository 18 may store a plurality of media assets. Each of the media assets may comprise media data that web server 16 may transmit to client devices 12.

In addition, web server 16 may provide data to client devices 12 that enable users of client devices 12 to select media assets and to control access to the media assets. For example, one or more of client devices 12 may run web browser applications. In this example, web server 16 may provide data to client devices 12 that the web browser applications may utilize to present webpages to the users of client devices 12. In this example, the webpages may include features that enable the users to select media assets and to control access to the media assets. In another example, one or more of client devices 12 may run special-purpose applications (e.g., “apps”). In this example, web server 16 may provide data to client devices 12 that the special-purpose applications may utilize to present features that enable the users to select media assets and to control access to the media assets.

Client devices 12 may present various search interfaces to the users of client devices 12 to enable the users to search for content and other information related to services delivered by computing system 10. Client devices 12 may generate and present such search interfaces based on data received by client devices 12 from computing system 10. In some examples, a search interface may form a portion of a larger graphical user interface (GUI). For example, a search interface may be a portion of a larger webpage or other type of GUI.

Each of the search interfaces includes features that enable a user to input search criteria. In response to receiving search criteria via the search interfaces, client devices 12 may send the search criteria to computing system 10. In response to receiving search criteria from one of client devices 12, computing system 10 may identify media assets, or other content, in media repository 18 that satisfy the search criteria. After identifying one or more media assets in media repository 18 that satisfy the search criteria, computing system 10 may send, via communication network 14, data identifying the one or more media assets that satisfy the search criteria. The client device may display, based on the data sent by computing system 10, a GUI that includes elements that identify the one or more media assets that satisfy the search criteria. If an identified media asset is already in a media library associated with the user, the GUI can indicate that the media asset is already in the media library associated with the user. For instance, the GUI may include badges that indicate media assets that are already in the media library associated with the user.

In one example, one of the search criteria may indicate that the media assets must be movies and that the media assets must be kid-friendly. In this example, computing system 10 responds to the search criteria by identifying kid-friendly movies in media repository 18 and sending data to the client device that identify the identified kid-friendly movies. In this example, the client device may display a GUI, such as a webpage, that includes data regarding the identified kid-friendly moves, such as titles, still images, DVD box art, posters, and so on.

When the client device displays data that identify the one or more media assets that satisfy the search criteria, the user may select one of the media assets. If the media asset is already in a media library associated with the user, the client device may begin playback of the media asset. If the media asset is not already in the media library associated with the user, the client device may display a message that asks the user whether the user would like to purchase or rent the media asset. If the user chooses to purchase the media asset, computing system 10 may permanently add the media asset to the user's media library. If the user chooses to rent the media asset, computing system 10 may temporarily add the media asset to the user's media library. In some examples, computing system 10 may assess a fee to the user for the purchase of the media asset.

If the user chooses to rent the media asset, computing system 10 may remove the media asset from the user's media library after the user has finished playing back the media asset, after a given amount of time has passed, or after another event has occurred. In some examples, computing system 10 may assess a fee to the user for the rental of the media asset. In some examples, the client device may indicate to the user that the user may purchase the media asset at a reduced price if the user has previously rented the media asset one or more times. In this manner, computing system 10 may be configured to deliver digital entertainment services including delivery of digital media assets on a rent-to-own basis.

In some examples, computing system 10 may store payment information, such as credit card, debit card, or bank account information, associated with the user. Computing system 10 may use this payment information when assessing a fee to the user for the purchase or rental of a media asset. Furthermore, in some examples, computing system 10 may require the user to enter a passcode, such as a PIN, before assessing the fee and adding the media asset to the user's media library.

As mentioned above, client device 12 may display search interfaces that enable users to identify media assets that may be of interest to the users. The search interfaces may have various appearances. For example, a search interface may comprise a text entry box that enables a user to type one or more search criteria. In another example, a search interface may comprise a series of menu boxes. In this example, each of the menu boxes may be associated with a different search criteria and each of the menu boxes may be displayed adjacent to a label of the search criteria associated with the menu boxes. For instance, a search interface may include a first menu box labeled “media type,” a second menu box labeled “genre”, a third menu box labeled “year/decade of first release,” a fourth menu box labeled “critics' ratings,” and so on.

In another example, a search interface may display a list of “trending” actors. The “trending” actors may be actors who are currently being frequently referred to in conventional and/or social media channels. The “trending” actors may also be actors that play roles in movies or other digital video assets that are frequently searched on or accessed by computing system 10. Example conventional media channels include television, newspapers, blogs, websites, and so on. Example social media channels include FACEBOOK™, TWITTER™, GOOGLE+™, and so on. When a user selects one of the “trending” actors from the search interface, a client device may display a set of graphical elements that identify media assets associated with the selected actor. For example, if the actor George Clooney is currently one of the “trending” actors and the user selects George Clooney from the list of “trending” actors, the client device may display graphical elements that identify media assets (such as the films “Ocean's Eleven”, “Three Kings”, etc.) associated with George Clooney. An actor may be associated with a media asset if the actor plays a role in the media asset, is a director or producer of the media asset, or is otherwise involved in the media asset. A similar search interface may display a list of “trending” characters or character types instead of “trending” actors. For example, if vampires, cowboys, and a particular superhero are currently being referred to frequently in various conventional and/or social media channels, the search interface may list “vampires”, “cowboys”, and the particular superhero.

In another example, a search interface may comprise a sentence template. The sentence template may include fixed text and one or more menu boxes. In other words, the fixed text may be interspersed with the menu boxes. The fixed text may include words or strings of characters that are not in the menu boxes. In some examples, the fixed text does not change in response to user input. Each of the menu boxes may display a selected menu item and may be associated with a control. When a user of a client device selects the control associated with a menu box, the client device displays a menu containing a plurality of selectable menu items. When the user selects one of the menu items, the client device may hide the menu and display the selected menu item in the menu box. In some instances, the control associated with the menu box is not separate from the selected menu item itself.

In this example, a user may form a natural-language sentence that describes the media assets of interest to the user by selecting appropriate menu items from the menu boxes positioned within the sentence template. After the user forms such a sentence, the client device may send to computing device 10 data indicating the selected menu items as the search criteria. Search interfaces that enable users to form natural-language sentences that describe the media assets of interest may be more helpful to some users than other types of search interfaces. For example, a client device may send a request to computing system 10, the request indicating selected menu items. In this example, the client device may receive a response from computing system 10, the response indicating the media assets that satisfy the criteria indicated by the sentence.

For example, a sentence template may include the phrase “I am looking for a”, followed by a first menu box, followed by the phrase “that's about”, followed by a second menu box, followed by the phrase “that's suitable for”, followed by a third menu box, followed by a period character. In this example, the first menu box may include menu items such as “movie”, “television program”, “sporting events,” “documentary”, and so on. The second menu box may include menu items such as “dogs”, “love”, “war”, “racing”, “cowboys”, and so on. The third menu box may include menu items such as “adults”, “families”, “toddlers”, “kids under 6”, “kids under 12”, “teenagers”, and so on. Thus, by selecting appropriate menu items, the user may form the sentence “I am looking for a movie that's about cowboys that's suitable for kids under 12.”

In some examples, a menu item from each of the menu boxes may be selected by default. For instance, when a client device initially displays the search interface, particular menu items may appear pre-selected in the menu boxes in the sentence template. For instance, in the example of the previous paragraph, the menu item “movie” may be pre-selected in the first menu box, the menu item “cowboys” may be pre-selected in the second menu box, and the menu item “families” may be pre-selected in the third menu box. The user may select different menu items in the menu boxes. Pre-selecting default menu items in the menu boxes may help guide users to media assets that are new or topical. Furthermore, in some examples, web server 16 may dynamically select, based on a user's past selections of media assets, which of the menu items are pre-selected.

In some examples, client devices 12 may dynamically modify the sentence template in response to the user selecting particular menu items from one or more of the menu boxes positioned within the sentence template. Furthermore, in some examples, client devices 12 may modify the sentence template in response to other user input, such as selecting a control to add an additional phrase and/or menu box.

Furthermore, in some examples, an administrator of web server 16 may modify the sentence template and/or menu items in the menu boxes. Furthermore, the administrator may modify which menu items of the menu boxes are selected by default. The administrator may perform such modifications for several reasons. For example, the administrator may modify the sentence template, menu items, and/or default menu items for holidays or seasons. In another example, the administrator may modify the sentence template, menu items, and/or default menu items in order to steer searches toward particular promoted media assets. The organization that delivers digital entertainment services via computing system 10 may use natural-language searches directed toward particular promoted media assets as a form of advertising, for which the organization may charge vendors and content providers. The administrator may also modify the order of the menu items of a menu box for similar reasons.

Search interfaces may include different sentence templates based on various criteria. For example, computing system 10 (or an administrator of computing system 10) may implement search interfaces that have different sentence templates based on days of the week, time of year, content to be featured, and so on.

In some examples, a client device may present a series of sentence templates. Each of the sentence templates may include fixed text and one or more menu boxes that enable a user to form complete natural-language sentences. In one example, a user may use menu boxes in a first sentence template to form a first complete sentence. The user may then select an appropriate on-screen control. When the user selects the appropriate on-screen control, the client may replace the first sentence template with a second sentence template in the series. The user may then use menu boxes in the second sentence template to form a second complete natural-language sentence. This process may continue with the user providing more information in each of the sentence templates. In this way, the user may provide information about the type of media assets that are of interest to the user by completing natural-language sentences in a “wizard”-style user interface. In other examples, a single search interface may concurrently display multiple sentence templates.

Furthermore, in some examples, the menu items selected in earlier sentence templates may affect which sentence templates are displayed later in the series. For instance, a computing device, such as client devices 12 or computing system 10, may determine a second sentence template based at least in part on particular menu items associated with a set of one or more menu boxes in a first sentence template. Each sentence template in the series may obtain increasingly-specific search criteria based on the user's selections in earlier sentence templates. In this manner, computing system 10 and/or client devices 12 may guide the user through a multi-tiered search in which the results of the search are increasingly narrowed at each step in the process, e.g., each time a user completes another natural-language search based on a sentence template including fixed text and one or more menu boxes that enable a user to form complete natural-language sentences. Such a multi-tiered, guided search provided by computing system and client devices 12 to a user, while possibly not providing as many options as a traditional advanced search utility, may be easier to and more natural for users to employ at least in part because it guides the user through the search process based on a relatively small number of criteria at each phase of the search.

An example of this multi-tiered, guided search may include a combination of the foregoing sentence template examples. For example, multi-tiered, guided search provided by computing system 10 and client devices 12 may include a first sentence template may include the phrase “I am looking for a”, followed by a first menu box, followed by the phrase “that's suitable for”, followed by a second menu box, followed by a period character. In this example, a user of one of client devices 12 may select menu items for the first and second menu boxes such that the completed search sentence reads “I am looking for a movie that's suitable for teenagers.” Computing system 10 may execute this search to return a narrowed set of media assets that match the requirements of the first sentence template. Client device 12 may then present the user a second sentence template that can, in some examples, be dependent on the answers to the first sentence template, and that can be configured to further narrow the search results of available media assets.

For example, client device 12 may present the user with a second sentence template that include the phrase “I would like to see a movie with”, followed by a first menu box, followed by the phrase “playing”, followed by a second menu box. In this example, the user of client device 12 may select menu items for the first and second menu boxes such that the completed search sentence reads “I would like to see a move with George Clooney playing a villain.” Computing system 10 may execute the second search based on the second sentence template to return a further narrowed set of media assets that match the requirements of the first sentence template. Computing system 10 may communicate the search results to client device 12, which, in turn, may present the search results to the user to select for viewing one of the movies that satisfied the multi-tiered, guided search criteria.

In other examples, computing system 10 and client device 12 may guide the user through a multi-tiered search including more than two steps, e.g., a search including three or more sentence templates. Additionally, the multi-tiered search may be executed at once instead of one search at a time, as described above. For example, computing system 10 may generate and client device 12 may present the user with a web page that includes the multiple sentence templates. In such an example, the user may complete all of the sentence templates by selecting menu items for each of the menu boxes provided in the natural-language search template and then select a control that indicates the user would like the search to be executed. In this example, computing system. Computing system 10 may execute the search based on all of the sentence templates completed by the user to return a set of media assets that match the requirements of all of the sentence templates. Computing system 10 may communicate the search results to client device 12, which, in turn, may present the search results to the user to select for viewing one of the movies that satisfied the multi-tiered, guided search criteria.

The users of client devices 12 may be associated with accounts with the digital entertainment service provided by computing system 10. Computing system 10 may store account database 20. Account database 20 may contain data associated with each user's account. Account database 20 may contain various types of data associated with a user's account. For example, account database 20 may contain a user's payment information (e.g., credit card information, debit card information, checking account information, etc.), a list of media assets that the user has purchased from the digital entertainment service, a list of media assets that the user has previously rented from the digital entertainment service, a list of media assets that the user is currently renting from the digital entertainment service, playlists of media assets that the user has purchased from the digital entertainment service, wish lists of media assets that the user would like to be given, data indicting user preferences, data regarding client devices associated with the user, and so on.

Some accounts may be associated with a plurality of users. For example, a single account may be established for an entire household (e.g., an entire family). In this example, the household may include parents and children. Different users associated with a single account may be interested in different media assets. For example, an account may be associated with a family that includes a father and a child. In this example, the father may be interested in action movies while the child may be interested in television programs about animals.

In order to make it easier for the multiple users associated with a single account to access the media assets that interest them, the account may have a plurality of sub-accounts (e.g., profiles). Each of the sub-accounts may correspond to a different user associated with the account. For example, an account may be associated with a household that includes a parent and two children. In this example, the account may have a first sub-account that corresponds to the parent, a second sub-account that corresponds to one of the children, and a third sub-account that corresponds to the other one of the children.

Each sub-account may be associated with data specific to the user that corresponds to the sub-account. For example, a sub-account that corresponds to a particular user may be associated with the particular user's media library, playlists, wish lists, account preferences, and so on. In this way, different users that are associated with the same account may have different media libraries, playlists, wish lists, account preferences, and so on.

When a user of a client device accesses the digital entertainment service, the client device may prompt the user to log in to the digital entertainment service. By logging in to the digital entertainment service, computing system 10 may be able to determine that the user is accessing the digital entertainment service through one of client devices 12.

Computing system 10 may transmit data to client devices 12. Client devices 12 may use this data to present different user interfaces that are associated with different sub-accounts of a single account. For example, client devices 12 may present user interfaces that present different playlists, wish lists, collections of media assets, etc. for different users associated with a single account. For instance, a first user interface may include graphical elements that identify a first set of one or more playlists curated by a user associated with a first sub-account associated with the account. A second user interface may include graphical elements that identify a different, second set of one or more playlists curated by a user associated with a second sub-account associated with the account.

If an account is associated with multiple sub-accounts, the client device may, prior to allowing the user to access media assets in the media library of the user, prompt the user to select one of the sub-accounts when logging in to the digital entertainment service. In other examples, if the account is associated with multiple sub-accounts, the client device may present a user interface associated with a default sub-account or a user interface associated with a most recently used one of the sub-accounts. The sub-account may be an active sub-account if the client device is currently displaying the user interface associated with the sub-account.

In some instances, after a user logs in to the digital entertainment service, a client device may present a user interface associated with another user's sub-account. For instance, a first user associated with an account may log in, but the client device may present the user interface associated with a second user associated with the account. Accordingly, the user interface includes one or more features that enable the user to switch which sub-account is currently active. The sub-account that is currently active may be referred to herein as the current sub-account. The user associated with the current sub-account may be referred to herein as the current user.

Some of the media assets in media repository 18 may not be suitable for all people. For example, some of the media assets in media repository 18 may include violent or sexual content that may not be suitable for younger users. Accordingly, parents may want to prevent their children from accessing particular media assets in media repository 18. To accomplish this, a user associated with an account may configure particular sub-accounts of the account such that the users that correspond to the sub-accounts are unable to access particular types of media assets. For example, a parent may configure a child's sub-account such that the child is unable to access PG-13 or R rated movies. In this example, the parent may configure the parent's sub-account such that the parent is able to access movies that have any rating. In this way, the digital entertainment system may implement parental controls.

Because different users associated with the same account may have access to different sets of media assets, computing system 10 may require a user to input a passcode, such as a personal identification number (PIN) or password, before switching to (e.g., logging into) a different sub-account. In this way, computing system 10 may prevent a user from accessing media assets that the user is not supposed to access simply by switching which sub-account is active.

As mentioned above, computing system 10 may assess a fee for the purchase or rental of a media asset. In some examples, a first user (e.g., a parent) associated with an account may configure the digital entertainment service such that computing system 10 automatically charges, to a payment instrument specified by the first user, a given amount of money. Computing system 10 may automatically charge the given amount of money on a one-time or on a recurring basis. In such examples, the given amount of money may be credited to a sub-account associated with a second user (e.g., a child). The second user may use the credited money to purchase or rent media assets from the digital entertainment service. In this way, the first user may, in effect, give the second user a one-time or periodic allowance for the purchase or rental of media assets from the digital entertainment service. In some examples, the user whose payment instrument is charged is not necessarily associated with the account. For example, instead of the first user being associated with the account, the first user may be a friend or relative of the second user.

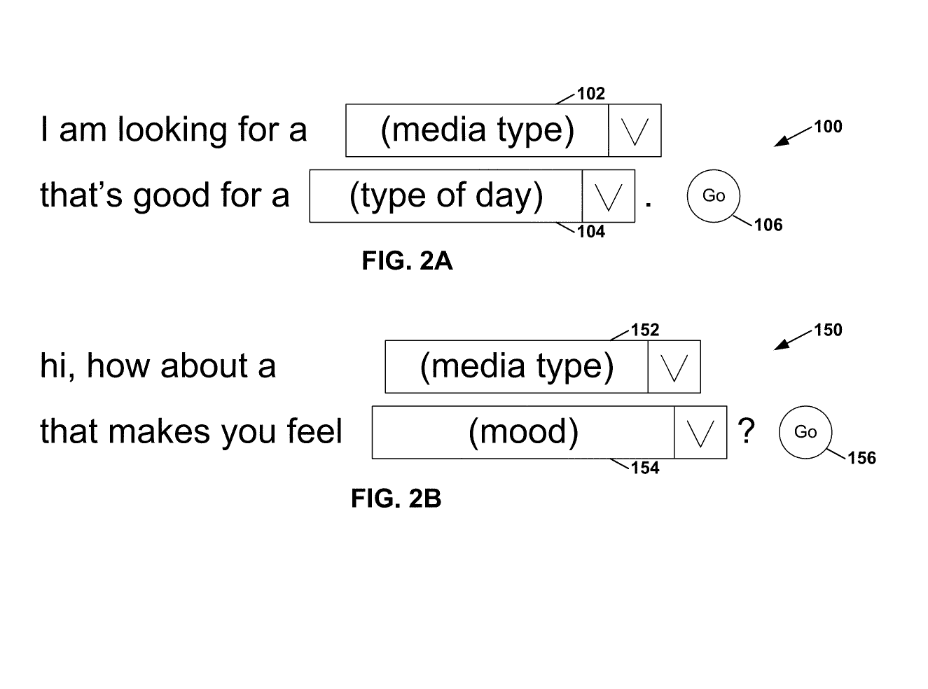

FIG. 2A is a conceptual diagram that illustrates an example search interface 100. Search interface 100 comprises a sentence template that includes a menu box 102 and a menu box 104. When a user selects menu box 102, menu box 102 may expand to reveal menu items associated with different media types, such as movies, television programs, and so on. In some examples, menu box 102 does not include the text “(media type)” as shown in the example of FIG. 2A. When the user selects menu box 104, menu box 104 may expand to reveal menu items associated with different types of day. For example, menu box 104 may expand to reveal menu items labeled “rainy day”, “exhausting day”, “kid's birthday”, and so on. Thus, in the example of FIG. 2A, the user may select menu items from menu box 102 and menu box 104 to form a sentence such as “I am looking for a movie that's good for a rainy day.” After selecting a menu item in menu box 102 and a menu item in menu box 104, the user may select a “Go” button 106 to search for media assets that correspond to the resulting sentence.

FIG. 2B is a conceptual diagram that illustrates another example search interface 150. Search interface 150 is similar to search interface 100 of FIG. 2B, but includes a different sentence template. As illustrated in the example of FIG. 2B, search interface 150 includes a sentence template that includes a menu box 152 and a menu box 154. When a user selects menu box 152, menu box 152 may expand to reveal menu items associated with different media types, such as movies, television programs, and so on. When the user selects menu box 154, menu box 154 may expand to reveal menu items associated with different moods. For example, menu box 154 may expand to reveal menu items labeled “happy”, “sad”, “excited”, “silly”, and so on. Thus, in the example of FIG. 2B, the user may select menu items from menu box 152 and menu box 154 to form a sentence such as “hi, how about a television program that makes you feel happy?” After selecting a menu item in menu box 152 and a menu item in menu box 154, the user may select a “Go” button 156 to search for media assets that correspond to the resulting sentence.

Many other examples may exist in addition to those illustrated in FIG. 2A and FIG. 2B. For example, a search interface may include a sentence template that includes a menu box that is associated with menu items that identify users of different sub-accounts of an account. For instance, in this example, the users “Christina”, “Johnny”, and “Sally” may be users of different sub-accounts of an account. Furthermore, in this example, the sentence template may include the fixed text “I am looking for a”, followed by a first menu box for a type of media asset, followed by the fixed text “that's a”, followed by a second menu box for a genre, followed by the fixed text “that's suitable for”, followed by a third menu box for the users of the sub-accounts. Hence, in this example, the user may use this sentence template to form the sentence “I am looking for a movie that's a western that's suitable for Johnny” In this example, computing system 10 may identify movies that are westerns and that have ratings that comply with the rating restrictions for the user “Johnny”.

In the foregoing example, computing system 10 may default to or require a particular user based on the currently active sub-account. For example, consider a family including a mother, Christina, and two children, Johnny and Sally. In such a case, if “Johnny” is the currently active sub-account and this sub-account is associated with certain parental controls configured by Johnny's mother Christina, then computing system 10 may default to or require “Johnny” in the third menu box. In the event, however, “Christina” is the currently active sub-account and this sub-account is associated with no parental controls, then computing system 10 may allow all possible values for the third menu box including “Christina”, “Johnny”, and “Sally.”

In some examples, a computing system (such as computing system 10) may generate data and send the data to a client device (such as any of client devices 12). The client device may use the data sent by the computing system to present graphical user interfaces, such as search interfaces 100 and 150. For example, the computing system may generate and send hypertext markup language (HTML) data. In this example, the client device may render the HTML data to present search interfaces 100 and/or 150.

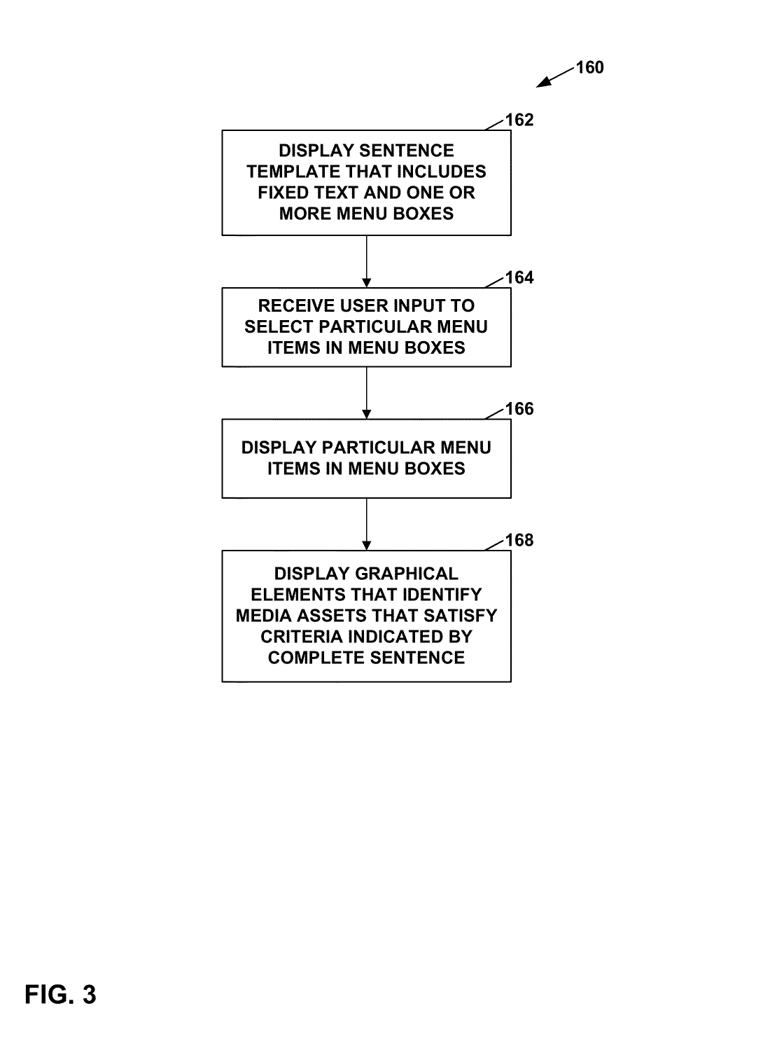

FIG. 3 is a flowchart that illustrates an example operation 160 for searching for media assets provided by a digital entertainment service such as the one described above with reference to computing system 10. As illustrated in the example of FIG. 3, a computing device, such as any of client devices 12, may display a sentence template that includes fixed text and one or more menu boxes (162). Each of the menu boxes may be associated with a different plurality of menu items. In addition, the computing device may receive user input to select particular menu items associated with the menu boxes (164). The computing device may display, in the menu boxes, the particular menu items associated with the menu boxes in response to receiving the user input to select the particular menu items (166). When the user selects the particular menu items, the fixed text and the particular menu items form a complete sentence in a language, such as English or French. In addition, the computing device may display graphical elements that identify media assets that satisfy criteria indicated by the complete sentence (168).

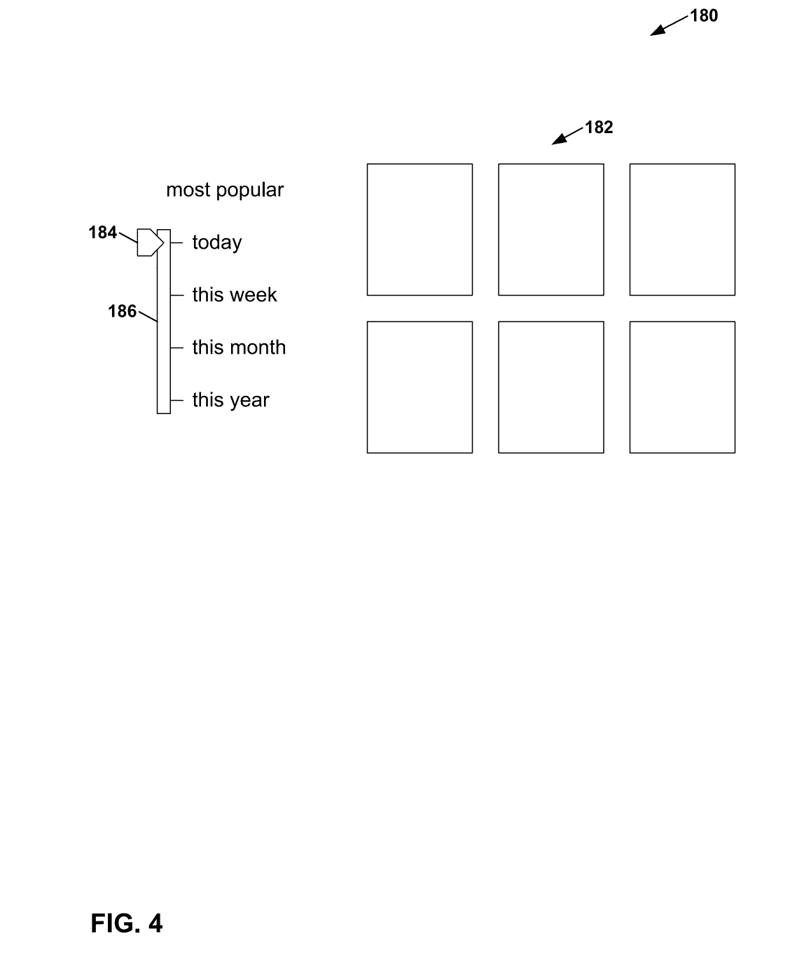

FIG. 4 is a conceptual diagram that illustrates an example asset group interface 180. A client device (e.g., one of client devices 12) may present asset group interface 180 to help a user find media assets that are potentially of interest to the user. Asset group interface 180 includes a plurality of asset elements 182. Each of asset elements 182 may be a graphical or textual element that identifies a media asset. For example, each of asset elements 182 may include a movie poster image for a movie.

A user may change which media assets are identified by asset elements 182 by changing a position of a slider element 184 along a slide bar 186. In the example of FIG. 4, slide bar 186 has four positions. The positions are labeled “today”, “this week”, “this month”, and “this year”. When slider element 184 is in the position labeled “today”, asset elements 182 identify the media assets that are most popular today. When slider element 184 is in the position labeled “today”, asset elements 182 identify the media assets that have been most popular this week. When slider element 184 is in the position labeled “this month”, asset elements 182 identify the media assets that have been most popular this month. When slider element 184 is in the position labeled “this year”, asset elements 182 identify the media assets that have been most popular this year.

Although the positions on slide bar 186 correspond to time periods in the example of FIG. 4, the positions on slide bar 186 may correspond to other criteria in other examples. Furthermore, in other examples, there may be more or fewer than four positions on slide bar 186. Additionally, instead of using criteria like “most popular,” as illustrated in the example of FIG. 4, other criteria could be the bases of time based content searches. For example, client device 12 may present a user with an asset group interface including the “most acclaimed” movies, television programs, or other media assets for “this year,” “last year,” or even a specific year provided by the user via client device 12.

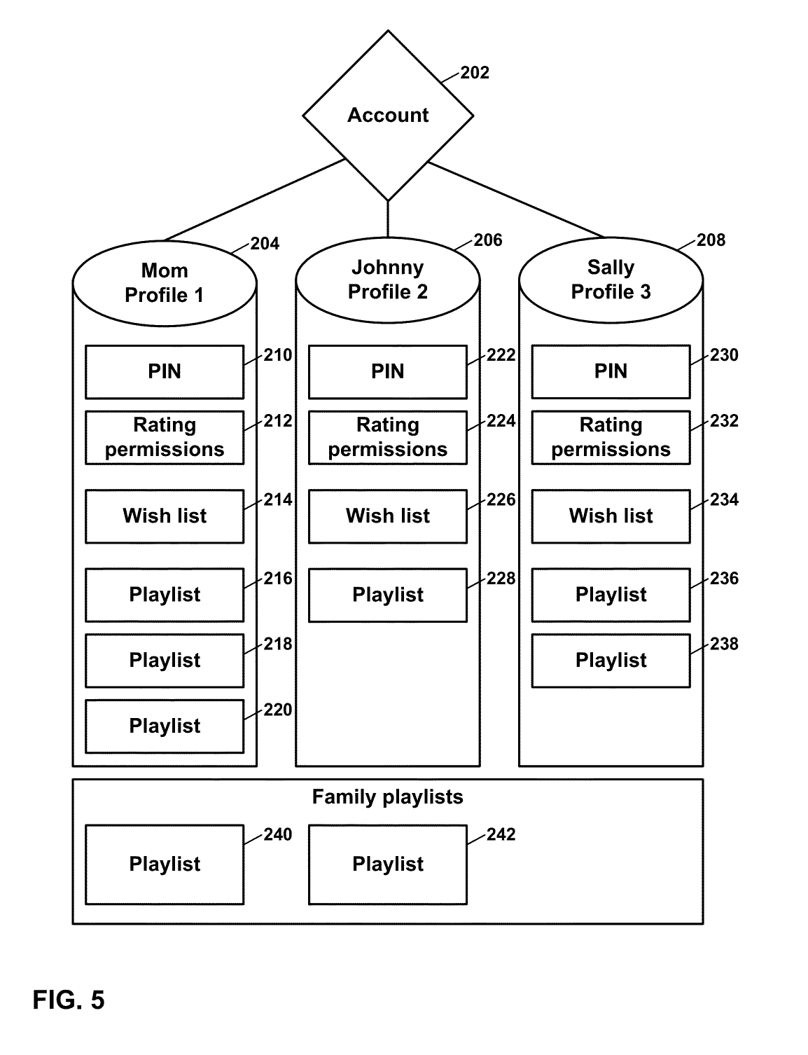

FIG. 5 is a conceptual diagram that illustrates an example account configuration for a digital entertainment services account. In the example of FIG. 5, an account 202 is associated with sub-accounts 204, 206, and 208. In the example of FIG. 5, sub-accounts are also referred to as “profiles.” Sub-account 204 is associated with a user named “Mom,” sub-account 206 is associated with a user named “Johnny,” and sub-account 208 is associated with a user named “Sally.”

As illustrated in the example of FIG. 5, each sub-account may be associated with its own PIN, rating permissions, wish list, and play lists. For instance, sub-account 204 is associated with a PIN 210, a set of rating permissions 212, a wish list 214, and playlists 216, 218, and 220. Sub-account 206 is associated with a PIN 222, a set of rating permissions 224, a wish list 226, and a playlist 228. Sub-account 208 is associated with a PIN 230, a set of rating permissions 232, a wish list 234, and playlists 236 and 238.

In addition to the playlists associated with sub-accounts 204, 206, and 208, account 202 may be associated with one or more family playlists. The family playlists may be available to each sub-account of account 202. Accordingly, user interfaces associated with different sub-accounts of the same account may include graphical elements that identify a set of one or more playlists shared by each sub-account associated with the account. In the example of FIG. 5, the family playlists include playlists 240 and 242.

As mentioned above, wish lists may be lists of media assets that the user would like to be given. Computing system 10 may prevent a user from adding a media asset to the wish list associated with the user's sub-account if the media asset does not conform to the rating restrictions associated with the user's sub-account. For example, if rating permissions 224 of sub-account 206 indicate that R rated movies cannot be accessed when sub-account 206 is active, computing system 10 may prevent the user from adding an R rated movie to wish list 226.

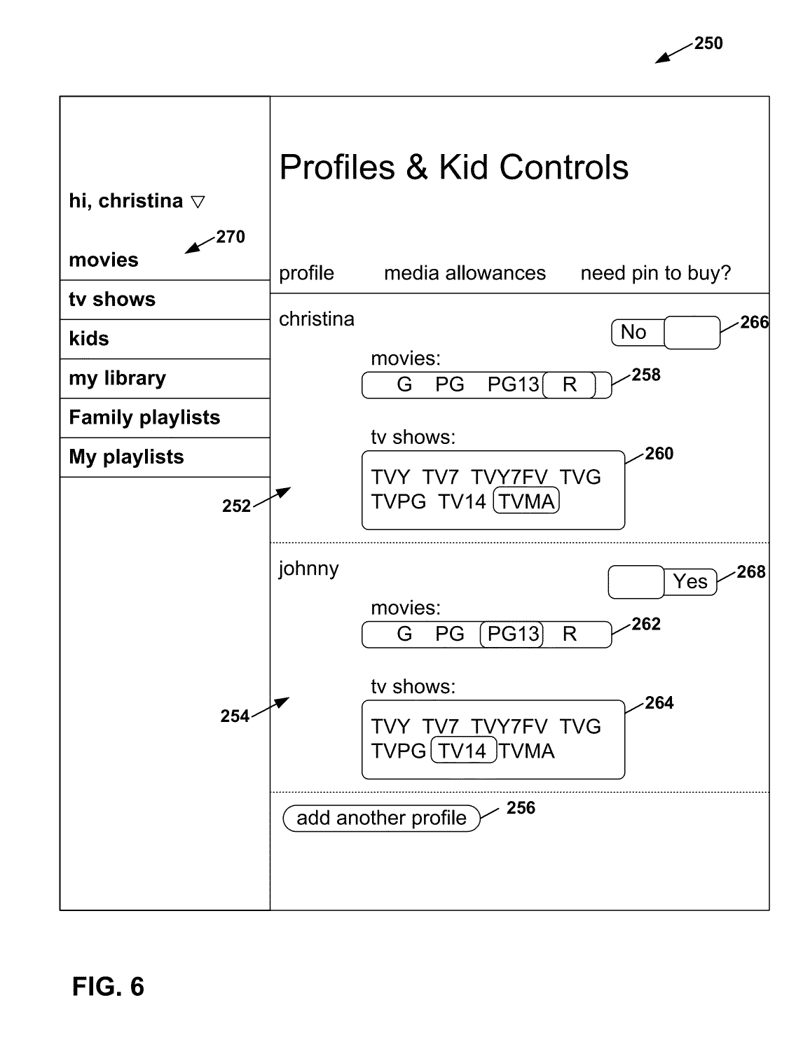

FIG. 6 is a conceptual diagram that illustrates an example sub-account configuration interface 250. A client device, such as any of client devices 12, may present sub-account configuration interface 250 to a user to enable the user to configure the sub-accounts associated with the user's account. For example, sub-account configuration interface 250 may include graphical elements that enable the user to set restrictions on types of media assets that the user and other users are allowed to access from the digital entertainment service.

In the example of FIG. 6, sub-account configuration interface 250 includes a region 252 for a first sub-account and a region 254 for a second sub-account. Region 252 is associated with a user named “Christina” and region 254 is associated with a user named “Johnny”. Sub-account configuration interface 250 also includes a button 256 to enable the user to add another sub-account to the account. Sub-account configuration interface 250 also includes controls 270 that enable the user to navigate to other user interfaces.

Region 252 includes a movie ratings control 258 and a TV show ratings control 260. The user may use movie ratings control 258 to select the rating of movies that the user “Christina” is allowed to access. In other words, the user may use movie ratings control 258 to select the ratings of movies that can be accessed when the sub-account associated with the user “Christina” is active. In the example of FIG. 6, movie ratings control 258 is set such that the user “Christina” is allowed to access R rated movies. The user may use TV show ratings control 260 to select the rating of TV shows that the user “Christina” is allowed to access. In other words, the user may use TV show ratings control 260 to select the ratings of TV shows that can be accessed when the sub-account associated with the user “Christina” is active. In the example of FIG. 6, TV show ratings control 260 is set such that the user “Christina” is allowed to access TV shows rated “TVMA.”

Similarly, region 254 includes a movie ratings control 262 and a TV show ratings control 264. The user may use movie ratings control 262 to select the rating of movies that the user “Johnny” is allowed to access. In the example of FIG. 6, movie ratings control 262 is set such that the user “Johnny” is allowed to access PG-13 rated movies. The user may use TV show ratings control 264 to select the rating of TV shows that the user “Johnny” is allowed to access. In the example of FIG. 6, TV show ratings control 264 is set such that the user “Johnny” is allowed to access TV shows rated “TV14.” Content restrictions other than ratings, e.g., Movie Picture Association of America (MPAA) ratings as illustrated in the foregoing examples, may be employed to control the content accessible by certain sub-accounts. For example, the user “Johnny” may be prohibited from watching any movies or other media assets containing nudity.

In this way, a computing device may a display user interface of a digital entertainment service. The user interface may include, for each sub-account in a plurality of sub-accounts associated with an account, graphical elements for setting access restrictions associated with the sub-account. The access restrictions for the sub-account indicating types of media assets that are allowed to be included in a media library associated with the sub-account.

Furthermore, in the example of FIG. 6, region 252 includes a pin-to-buy control 266. The user may use pin-to-buy control 266 to configure whether the user “Christina” must enter a PIN before being able to buy or rent a media asset. In other words, the user may use pin-to-buy control 266 to configure whether a PIN must be entered to buy or rent a media asset when the sub-account associated with the user “Christina” is active. The PIN to buy or rent a media asset may be the same or different than the PIN used to switch to the sub-account associated with the user “Christina”. Similarly, region 254 includes a pin-to-buy control 268. The user may use pin-to-buy control 268 to configure whether the user “Johnny” must enter a PIN before being able to buy or rent a media asset. The PIN to buy or rent a media asset may be the same or different than the PIN used to switch to the sub-account associated with the user “Johnny”.

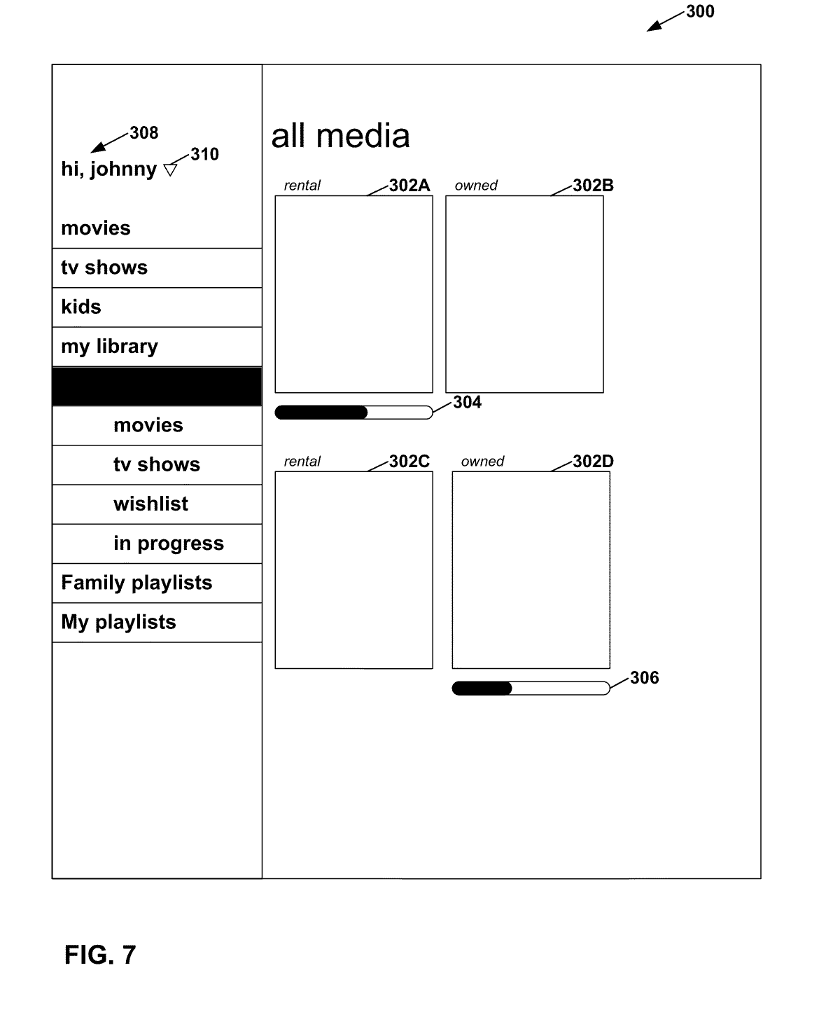

FIG. 7 is a conceptual diagram that illustrates an example media selection interface 300. Media selection interface 300 includes asset elements 302A-304D (collectively, “asset elements 302”). Each of asset elements 302 identifies a media asset in a media library associated with a user. For example, each of asset elements 302 may include a movie poster or a publicity shot from a media asset, such as a movie or television program.

In some instances, a user does not finish watching a media asset. In instances where a user does not finish watching a media asset, media selection interface 300 may include a progress bar that indicates how much of the media asset has been watched. In the example of FIG. 7, media selection interface 300 includes progress bars 304 and 306. Playback of a partially watched media asset may resume at the point where playback of the media asset previously stopped. For example, if a client device receives a user selection of asset element 302A, playback of the media asset identified by asset element 302A may resume at a point approximately halfway through the media asset. Different users associated with the same account but different sub-accounts may separately watch the same media asset. Accordingly, the different users may resume playback of the media asset at different points within the media asset by accessing the media asset when that user's sub-account is active.

In addition, media selection interface 300 includes a user identification element 308 that identifies the current user and/or currently active sub-account. In the example of FIG. 7, the current user is named “Johnny” Media selection interface 300 also includes a sub-account selection control 310. When the user selects sub-account selection control 310, media selection interface 300 may display a profile selection menu. The sub-account selection menu may include menu items that identify other users associated with other sub-accounts of the user's account. The user may switch to (e.g., log in to) another sub-account by selecting one of the menu items in the sub-account selection menu.

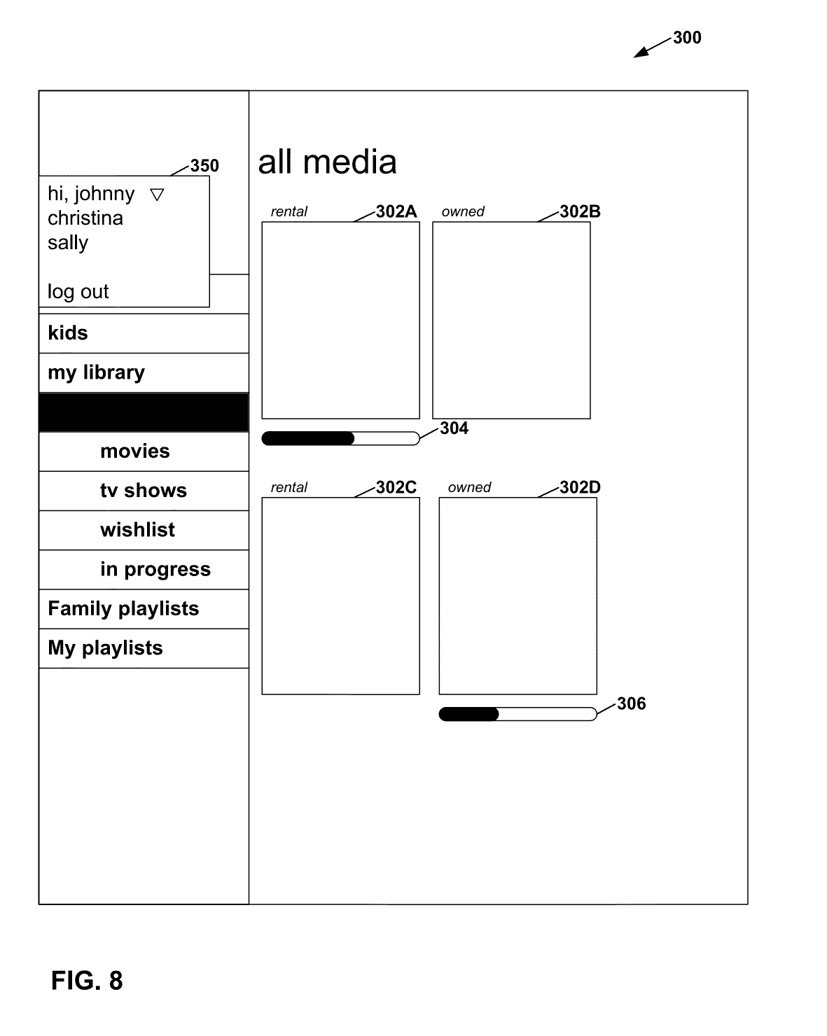

FIG. 8 is a conceptual diagram that illustrates the example media selection interface 300 of FIG. 7 with an expanded sub-account selection menu 350. As illustrated in the example of FIG. 8, sub-account selection menu 350 includes menu items for users named “Johnny”, “Christina”, and “Sally”. The users “Johnny”, “Christina”, and “Sally” may be associated with different sub-accounts of a single account. Sub-account selection menu 350 also includes a menu item to log out of the digital entertainment service.

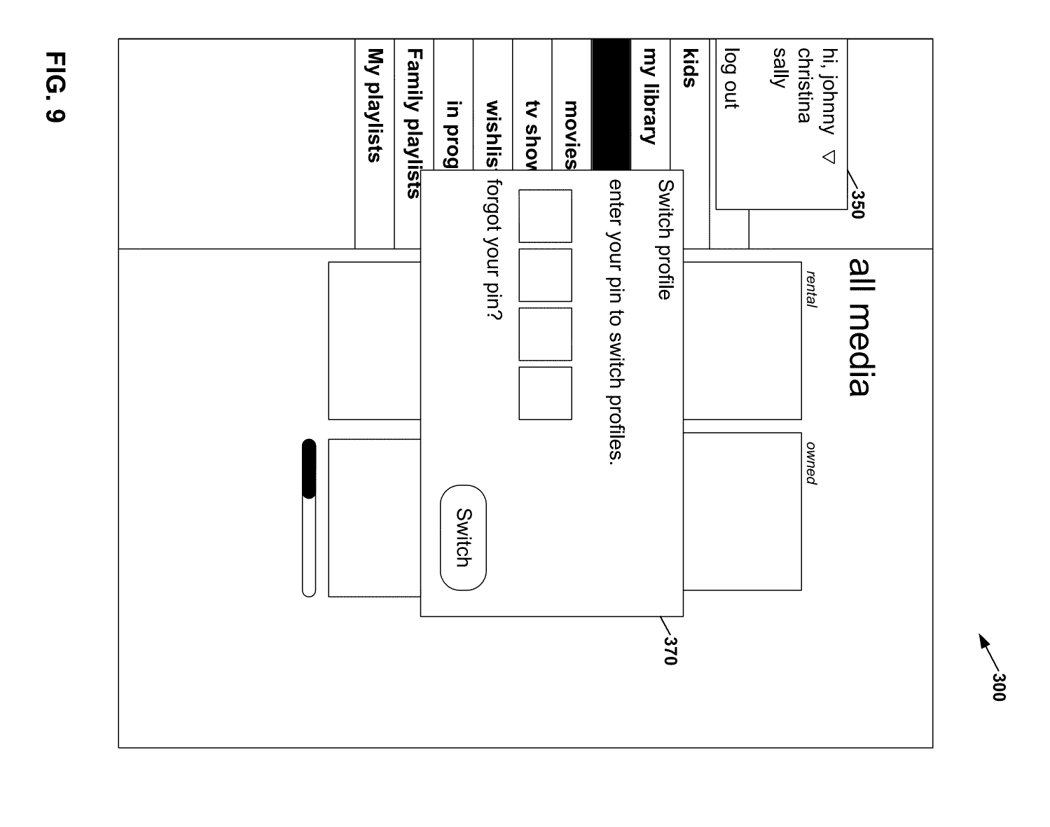

FIG. 9 is a conceptual diagram that illustrates the example media selection interface 300 of FIG. 8 with a personal identification number (PIN) entry window 370. PIN entry window 370 includes elements that enable the user to input a PIN. A client device may display PIN entry window 370 in response to the user selecting a menu item in sub-account selection menu 350.

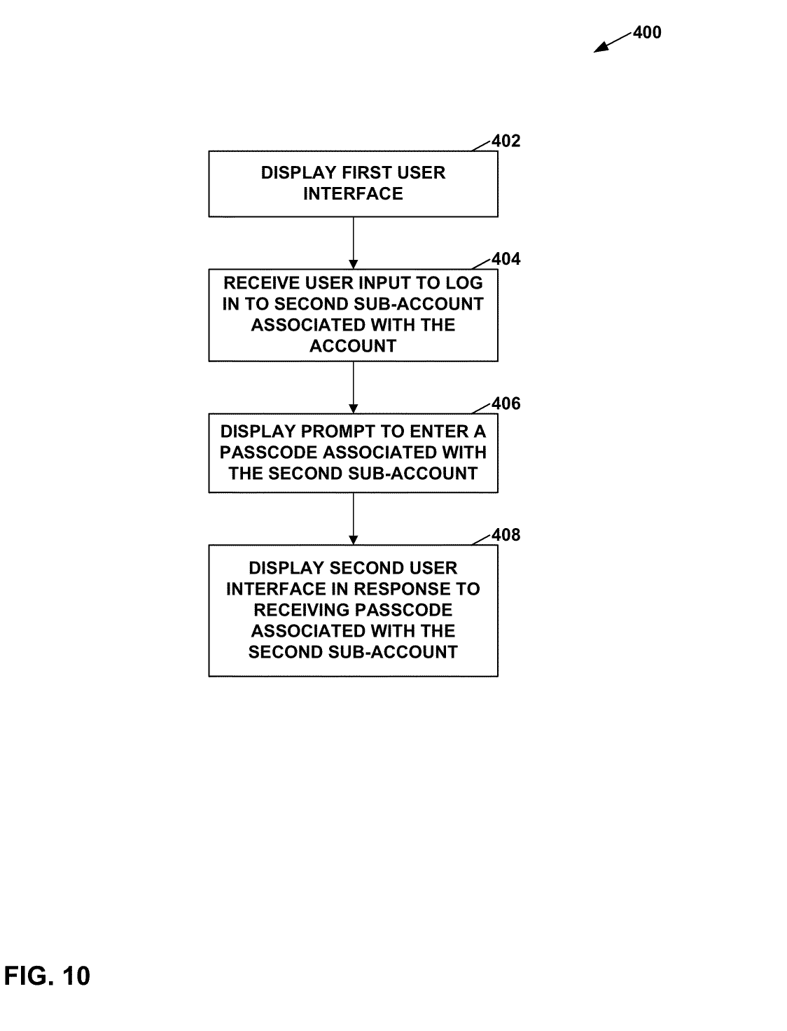

FIG. 10 is a flowchart that illustrates an example operation 400 for changing sub-accounts. In the example of FIG. 10, a computing device, such as any of client devices 12, displays a first user interface of a digital entertainment service (402). The first user interface may include graphical elements that identify digital media assets associated with a first sub-account of an account. Subsequently, the computing device may receive user input to log in to a second sub-account of the account (404). The computing device may display, in response to receiving the user input to log in to the second sub-account, a prompt to enter a passcode associated with the second sub-account (406). The computing device may display, in response to receiving user input of the passcode associated with the second sub-account, a second user interface of the digital entertainment service (408). The second user interface includes graphical elements that identify digital media assets associated with the second sub-account.

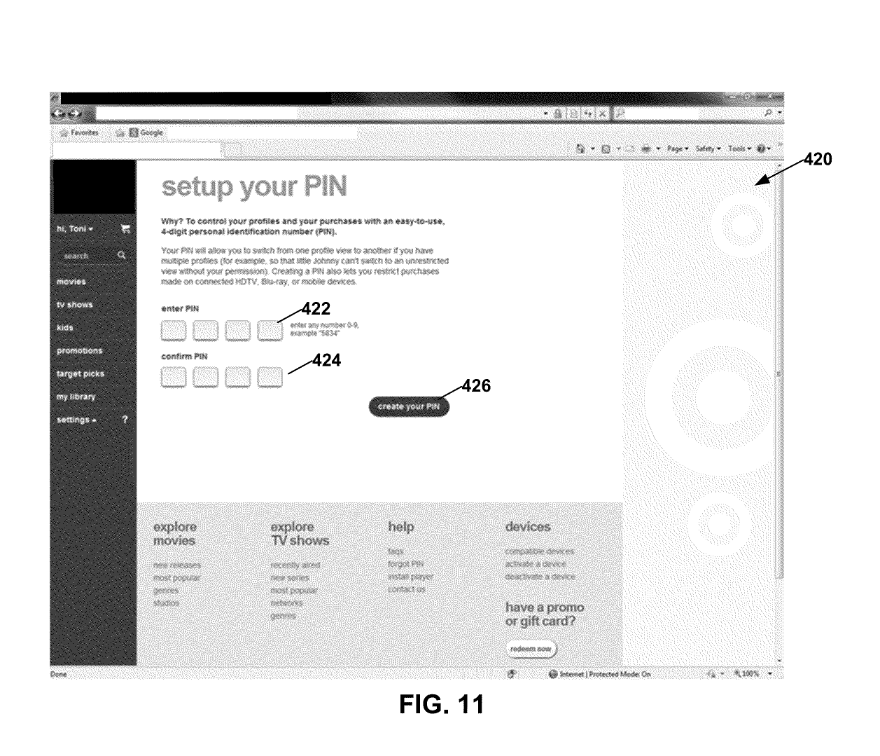

FIG. 11 is a conceptual diagram that illustrates an example sub-account configuration interface 420, in accordance with one or more techniques of this disclosure. A client device, such as any of client devices 12, may present sub-account configuration interface 420 to a user to enable the user to setup the PIN for the primary account or sub-accounts associated with the user's primary account. For example, sub-account configuration interface 420 may include graphical elements 422 that enable the user to enter a PIN and graphical elements 424 that enable the user to confirm the PIN for the primary user “Toni”. Example sub-account configuration interface 420 may further include graphical elements 426 that enable the user to click “create your PIN” when the user has complete entry and confirmation of their PIN.

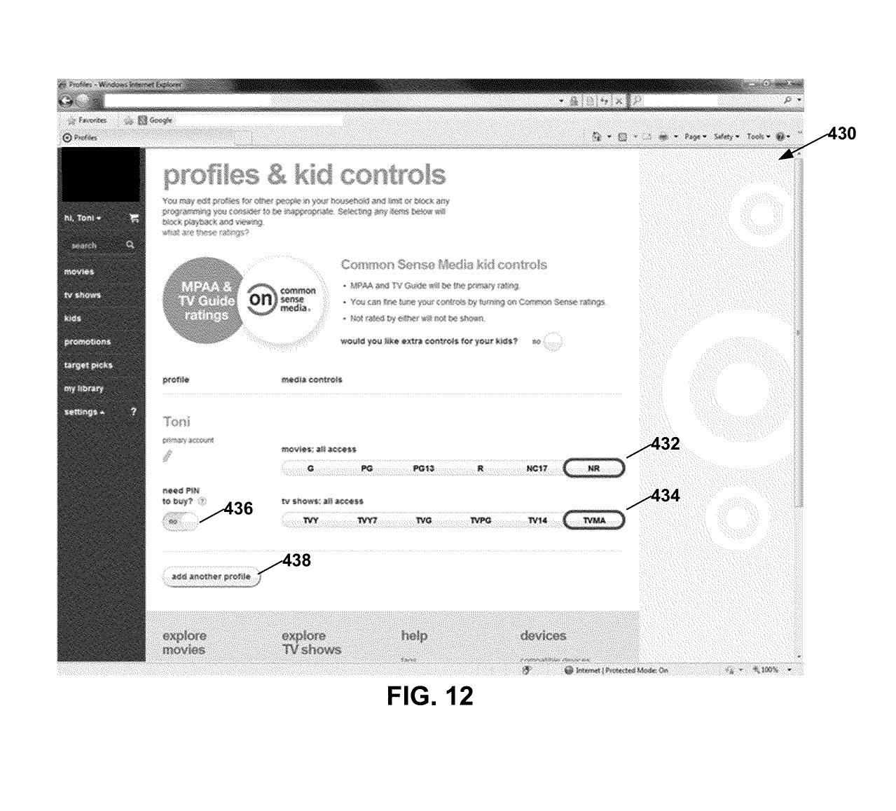

FIG. 12 is a conceptual diagram that illustrates an example account configuration interface 430, in accordance with one or more techniques of this disclosure. A client device, such as any of client devices 12, may present account configuration interface 430 to a user to enable the user to configure the user's primary account. For example, account configuration interface 430 includes a movie ratings control 432 and a TV show ratings control 434. The user may use movie ratings control 432 to select the rating of movies that the user “Toni” is allowed to access. In other words, the user may use movie ratings control 432 to select the ratings of movies that can be accessed when the primary account associated with the user “Toni” is active. In the example of FIG. 12, movie ratings control 432 is set such that there is no rating limit (NR) to the movies that the user “Toni” is allowed to access. Similarly, the user may use TV show ratings control 434 to select the rating of TV shows that the user “Toni” is allowed to access. In other words, the user may use TV show ratings control 434 to select the ratings of TV shows that can be accessed when the primary account associated with the user “Toni” is active. In the example of FIG. 12, TV show ratings control 434 is set such that the user “Toni” is allowed to access TV shows rated “TVMA.”

Account configuration interface may further include graphical elements such as a need PIN to buy control 436. The user may use need PIN to buy control 436 to set whether the user needs to enter a PIN number before the user is permitted to purchase media when the primary account associated with the user “Toni” is active. In this example, the need PIN to buy control 436 is set to “no”, meaning that a PIN number is not required when the primary account associated with the user “Toni” is active.

Account configuration interface 430 may further include graphical elements such as add another profile control 438. The user may click on add another profile control 438 to bring up a sub-account configuration interface which allows the user to create and configure a sub-account associated with the user's primary account.

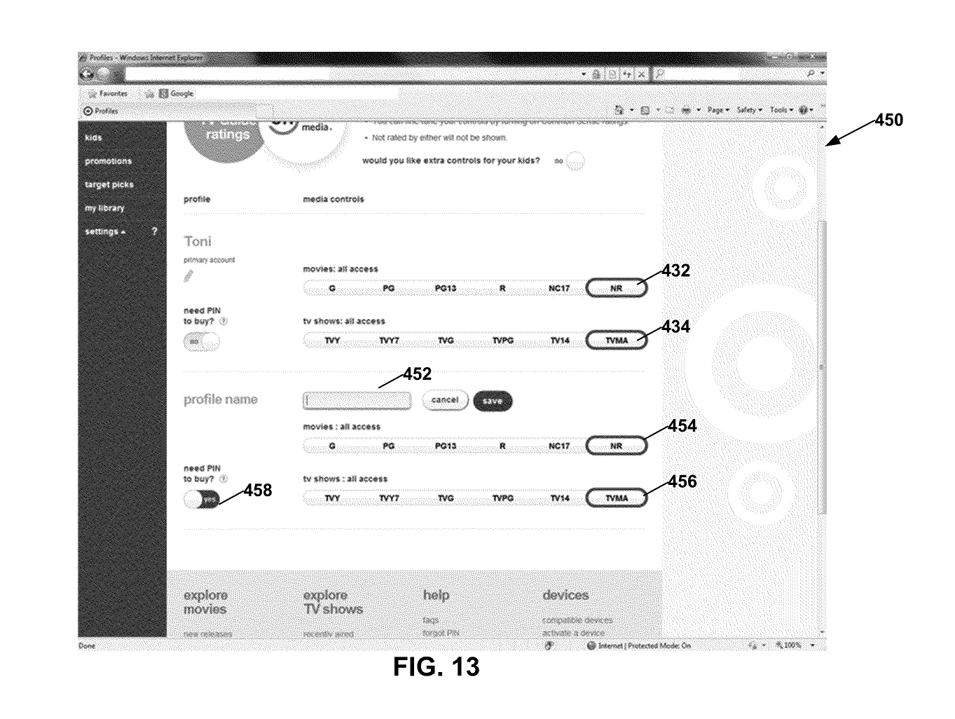

FIG. 13 is a conceptual diagram that illustrates an example sub-account configuration interface 450, in accordance with one or more techniques of this disclosure. In the example of FIG. 6, sub-account configuration interface 250 includes graphical elements 432 and 434 associated with a primary account as discussed above with respect to FIG. 12. Sub-account configuration interface further includes graphical elements that permit the primary user to configure a subaccount. For example, configuration interface 450 includes graphical element 452 that permit the primary user to enter a profile name associated with this sub account. Configuration interface 450 further includes a movie ratings control 454 and a TV show ratings control 456. The primary user may use movie ratings control 454 to select the rating of movies that the user associated with this subaccount is allowed to access and TV show ratings control 456 to select the rating of TV shows that the user associated with this subaccount is allowed to access

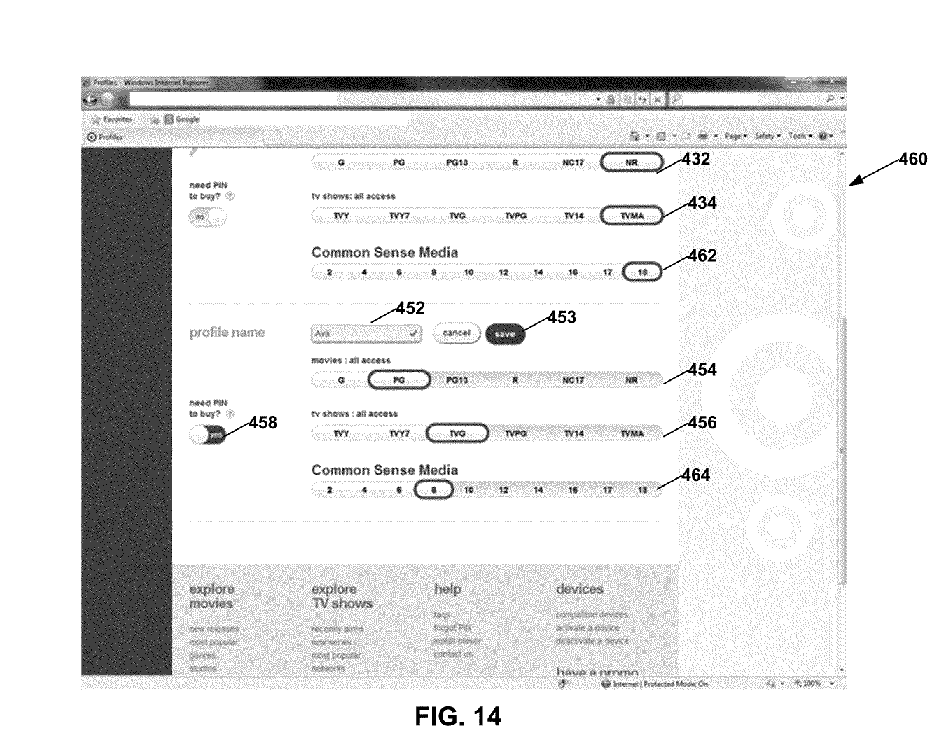

FIG. 14 is a conceptual diagram that illustrates an example sub-account configuration interface 460, in accordance with one or more techniques of this disclosure. As shown the example of FIG. 14, the user has entered the name “Ava” into profile name text entry box 452 for this particular subaccount. In addition, movie ratings control 454 is set such that the user “Ava” is allowed to access PG rated movies. TV show ratings control 456 is set such that the user “Ava” is allowed to access TV shows rated “TVG.”

Content restrictions other than ratings, e.g., Movie Picture Association of America (MPAA) ratings, Common Sense Media ratings, and other ratings, designations, or types of content restrictions may also be used to control the content accessible by the primary or one or more of the sub-accounts. In the example of FIG. 14, a Common Sense Media control 462 is presented for the primary user “Toni” and a Common Sense Media control 464 is presented for the sub-account associated with the user “Ava”. The Common Sense Media ratings are based on age appropriateness and learning potential as determined by the organization Common Sense Media, Inc. In this example, Common Sense Media control 462 is set such that the user “Toni” is allowed to access content designated appropriate for ages 18 and over, and Common Sense Media control 464 is set such that the user “Ava” is allowed to access content designated appropriate for ages 8 and under.

Sub-account configuration interface 460 may further include graphical elements such as a need PIN to buy control 458 associated with the sub-account “Ava”. In this example, the need PIN to buy control 458 is set to “yes”, meaning that a PIN number is required when the primary account associated with the user “Ava” is active. In other words, the user may use pin-to-buy control 458 to configure whether a PIN must be entered to buy or rent a media asset when the sub-account associated with the user “Ava” is active. The PIN to buy or rent a media asset may be the same or different than the PIN used to switch to the sub-account associated with the primary user “Toni” or with any other sub-accounts associated with the primary user “Toni.”

Sub-account configuration interface 460 may further include graphical elements such as cancel and save controls 453. The primary user may click on “save” when they have completed set up of the sub-account associated with the user “Ava”. Conversely, the user may click on “cancel” if they decide not to create the sub-account.

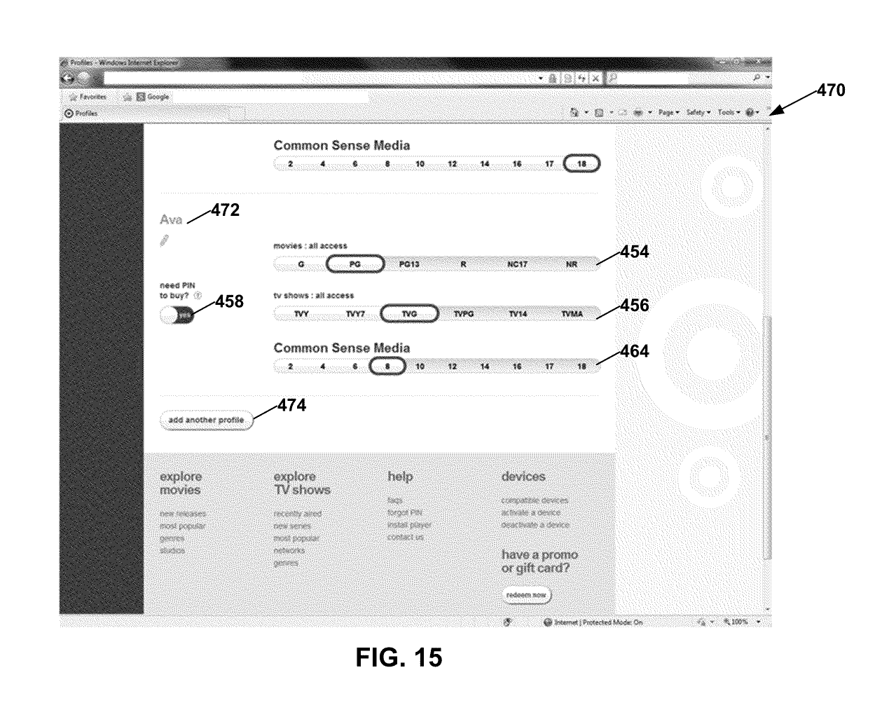

FIG. 15 is a conceptual diagram that illustrates an example sub-account configuration interface 470, in accordance with one or more techniques of this disclosure. Sub-account configuration interface 470 may be presented when the primary user clicks “save” on cancel and save control 453. Region 472 indicates the sub-account associated with the user “Ava” and shows all of the configuration controls as they were set-up during the configuration phase as shown in FIG. 14. Sub-account configuration interface 470 further includes add another profile control 474. The user may click on add another profile control 474 to bring up a sub-account configuration interface which allows the user to create and configure another sub-account associated with the user's primary account.

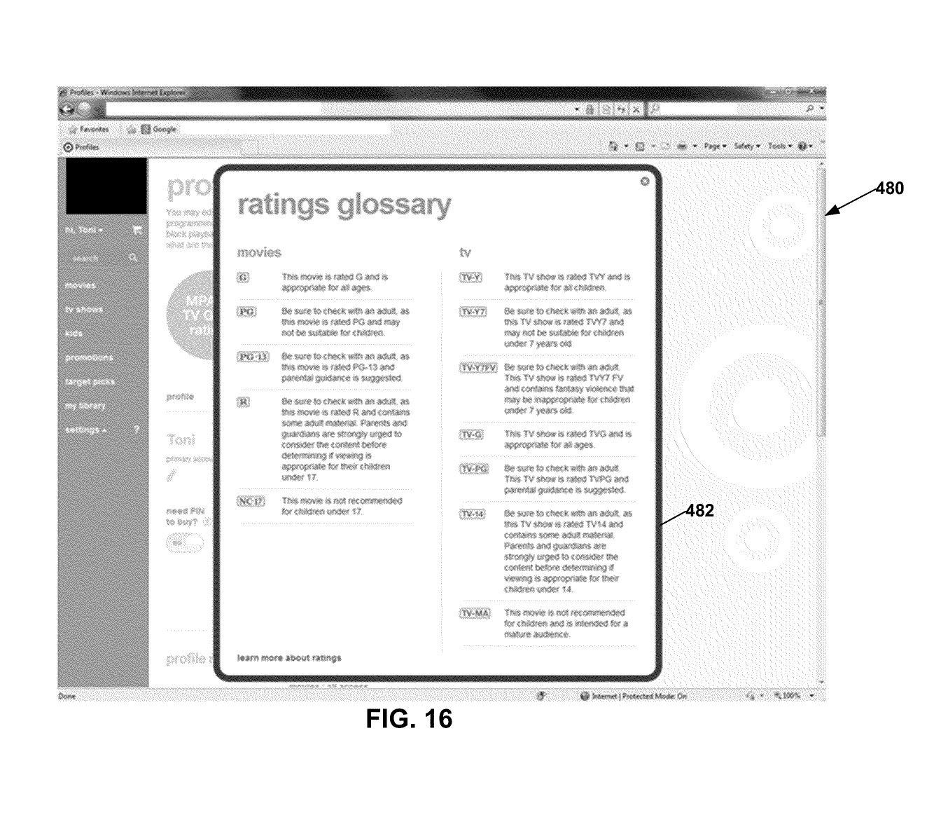

FIG. 16 is a conceptual diagram that illustrates an example ratings glossary interface 480, in accordance with one or more techniques of this disclosure. In the example of FIG. 16, a computing device, such as any of client devices 12, may display ratings glossary interface 480. Ratings glossary interface 480 includes a ratings glossary 482 that presents detailed definitions of the movie and TV ratings presented in the sub-account configuration interfaces. A user may choose to view and consult the ratings glossary when determining how to configure the primary account and/or one or more sub-accounts associated with the primary account. In this example, the ratings glossary shows movie ratings associated with the Motion Picture Association of America and TV ratings associated with the TV Parental Guidelines. However, it shall be understood that other ratings may also be included in the glossary, such as Common Sense Media ratings, or other types of ratings or descriptions that may be used to configure a primary account or one or more sub-accounts associated with the primary account.

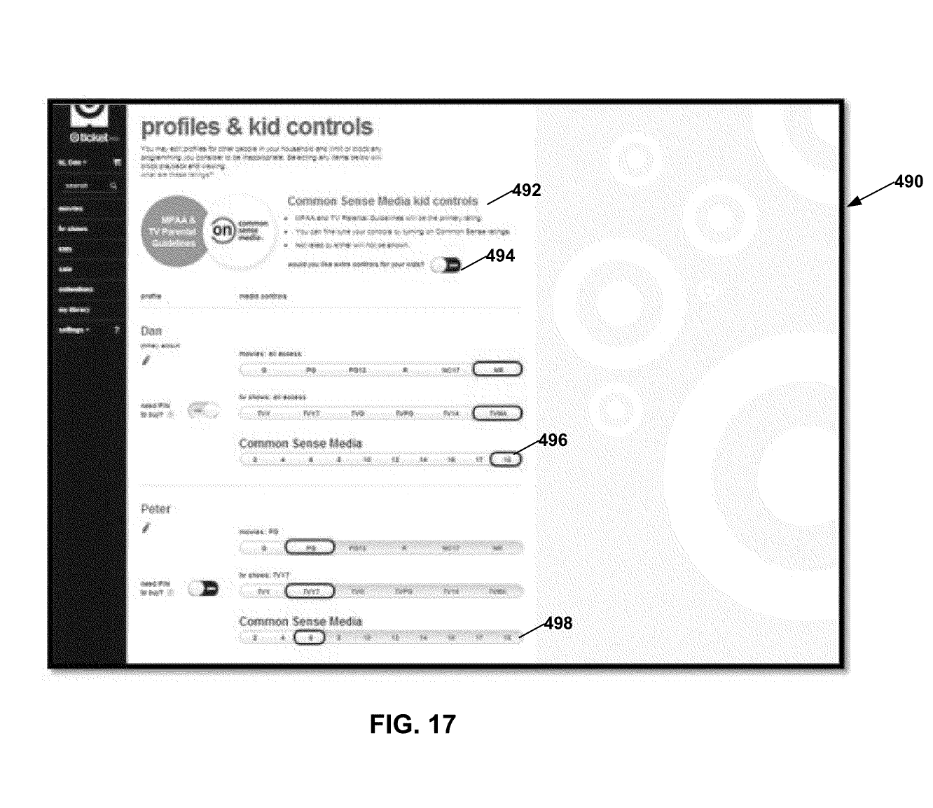

FIG. 17 is a conceptual diagram that illustrates an example sub-account configuration interface 490, in accordance with one or more techniques of this disclosure. FIG. 14 is a conceptual diagram that illustrates an example sub-account configuration interface 460, in accordance with one or more techniques of this disclosure. As shown the example of FIG. 14, sub-account configuring interface 490 includes a common sense media control 494. Control 494 permits the primary account owner, in this case, a user “Dan,” to choose whether or not to include one or more additional sets of media controls, in this case Common Sense Media controls, for each sub-account. When one or more additional sets of media controls are on, configuration interface 490 displays a Common Sense Media control 496 for the primary account, “Dan,” and a Common Sense Media control 498 for the sub-account, “Peter.” These are in addition to a movie ratings control and a TV show ratings control for both the primary account and the sub-account. In this example, the additional set of media controls is a Common Sense Media control that corresponds to age appropriateness ratings determined by the organization Common Sense Media, Inc. However, it shall be understood that other age appropriateness ratings may also be used, and that the disclosure is not limited in this respect. Also, it shall be understood that other types of media and/or ratings controls may also be used. As shown in the example of FIG. 17, the Common Sense Media control 496 is set to “18” for primary account holder “Dan” and the Common Sense Media control 498 is set to “6” for sub-account associated with the user “Peter.”

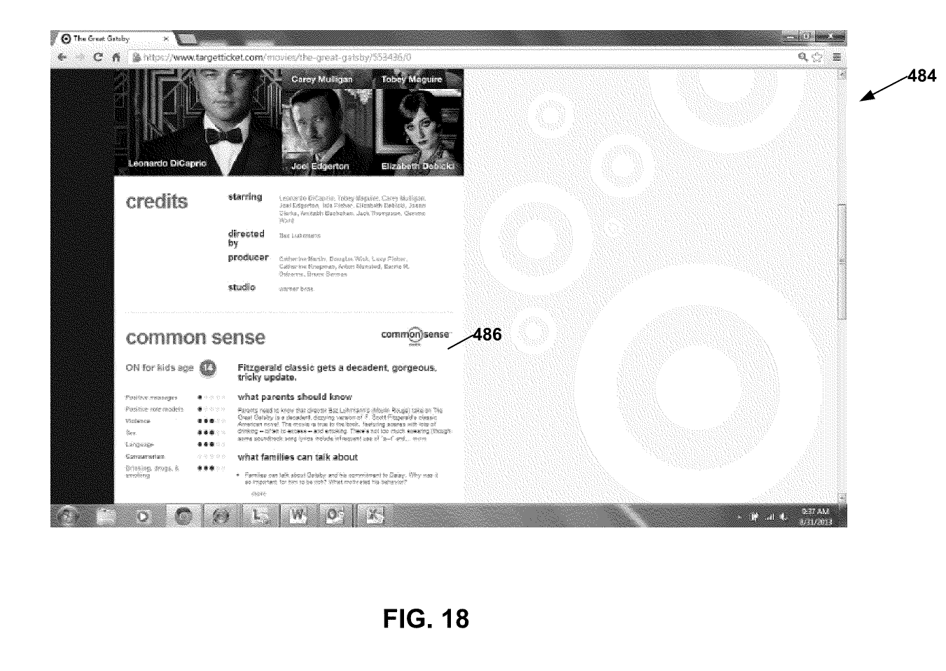

FIG. 18 is a conceptual diagram that illustrates an example interface 486, in accordance with one or more techniques of this disclosure. In this example, Common Sense Media information 488 concerning the movie “The Great Gatsby” is displayed. In this way, a digital media service may permit users to view the Common Sense Media ratings and detailed age appropriateness analysis when deciding whether or not to view a particular movie or to allow their children to view a particular movie.

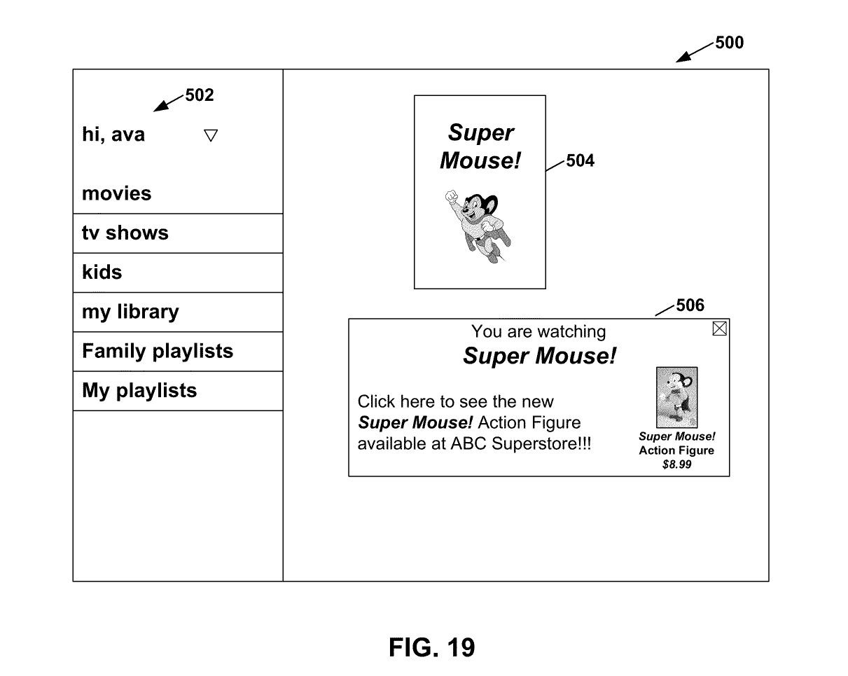

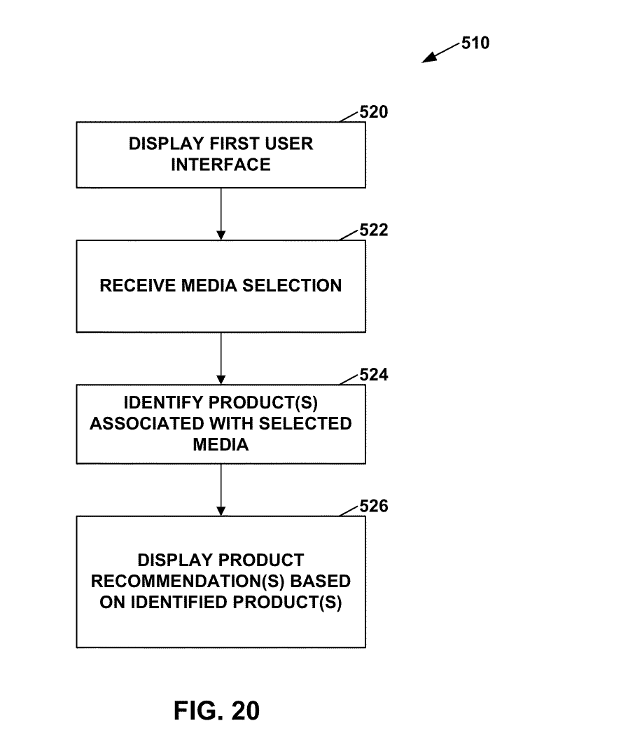

FIG. 19 is a conceptual diagram that illustrates an example media viewing interface 500 that includes a product recommendation, in accordance with one or more techniques of this disclosure. A client device, such as any of client devices 12, implementing the digital entertainment service may present media viewing interface 500 to a user that allows a user to view selected media content. In this example, the sub-account is associated with a user “Ava” as indicated in region 502 and the selected media is the movie “Super Mouse!” as indicated by icon 504. In some examples, the digital entertainment service may include a product recommendation feature. For example, the digital entertainment service may generate product recommendations based on the selected media content.

The recommendation engine may be implemented using, for example, collaborative-based filtering, content-based filtering, or a combination thereof. Other recommendation systems may also be used, and the disclosure is not limited in this respect. Collaborative filtering bases recommendations on a user's past behavior (e.g., items previously purchased or selected and/or numerical ratings given to those items) as well as similar decisions made by other users, then use that model to predict products that the user may have an interest in. Content-based filtering bases recommendations upon discrete characteristics of an item in order to recommend additional items with similar properties.

In this example, the selected media is the movie “Super Mouse!” as indicated by icon 504. A recommendation engine may generate one or more product recommendations based on the selected media. In this example, the recommendation engine has generated a pop-up window 506 displayed on interface 500 that contains a product recommendation for a Super Mouse! Action Figure. The product recommendations may also be presented as an advertisement before, during, or after the media is played. The product recommendations may also be presented as a side bar, scrolling message, or any other means of displaying a product recommendation. From the product recommendation, the digital entertainment service may provide any of several ecommerce features. For example, a user may add a recommended product to a shopping cart, proceed directly to checkout, continue shopping, or go to the shopping cart page to view the cart contents. The product recommendation can be closed, for example, by clicking the close window button at the top right hand corner, by pressing the [Esc] key, or by clicking anywhere outside the product recommendation. The digital entertainment service may also remove product recommendation from the interface if there has been no user interaction with the product recommendation for a predetermined period of time.

Using one or more of the techniques described herein, a computing device may a display user interface of a digital entertainment service. The user interface may include, for each sub-account in a plurality of sub-accounts associated with an account, graphical elements for setting access restrictions associated with the sub-account. The access restrictions for the sub-account indicating types of media assets that are allowed to be included in a media library associated with the sub-account.

The attached drawings illustrate examples. Elements indicated by reference numbers in the attached drawings correspond to elements indicated by like reference numbers in the following description. In the attached drawings, ellipses indicate the presence of one or more elements similar to those separated by the ellipses. Alphabetical suffixes on reference numbers for similar elements are not intended to indicate the presence of particular numbers of the elements. In this disclosure, elements having names that start with ordinal words (e.g., “first,” “second,” “third,” and so on) do not necessarily imply that the elements have a particular order. Rather, such ordinal words are merely used to refer to different elements of a same or similar type.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk, and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

1. A method comprising:
displaying, by a computing device, a sentence template that includes fixed text and one or more menu boxes, each of the menu boxes being associated with a different plurality of menu items;
displaying, by the computing device, particular menu items associated with the menu boxes in response to receiving user input to select the particular menu items, wherein the fixed text and the particular menu items form a complete sentence in a human language; and
displaying, by the computing device, graphical elements that identify media assets that satisfy criteria indicated by the complete sentence.

2. The method of claim 1,
wherein the graphical elements include a particular graphical element that identifies a particular media asset; and
wherein the method further comprises offering, by the computing device, the particular media asset for sale or rent in response to receiving user input to select the particular graphical element.

3. The method of claim 1, further comprising:
sending, by the computing device, a request to a server system, the request indicating the particular menu items; and
receiving, by the computing device, a response from the server system, the response indicating the media assets that satisfy the criteria indicated by the complete sentence.

4. The method of claim 1, further comprising modifying, by the computing device, the sentence template in response to receiving the user input to select one or more of the particular menu items.

5. The method of claim 1, wherein the one or more menu boxes initially display default menu items, the default menu items selected to guide users to promoted media assets.

6. The method of claim 1, wherein the sentence template is a first sentence template, the fixed text is a first fixed text, the one or more menu boxes are a first set of one or more menu boxes, the complete sentence is a first complete sentence, and the method further comprises:
displaying, by the computing device, a second sentence template, the second sentence template including a second fixed text and a second set of one or more menu boxes; and
displaying, by the computing device, selected menu items associated with the second set of one or more menu boxes in response to receiving user input to select the selected menu items associated with the second set of one or more menu boxes, wherein the second fixed text and the selected menu items associated with the second set of one or more menu boxes form a second complete sentence in the human language, wherein the graphical elements identify media assets that satisfy the criteria indicated by the first and second complete sentences.

7. The method of claim 6, further comprising, determining, by the computing device, the second sentence template based at least in part on the particular menu items associated with the first set of one or more menu boxes.

8. A computing device that comprises one or more processors configured to:
display a sentence template that includes fixed text and one or more menu boxes, each of the menu boxes being associated with a different plurality of menu items;
receive user input to select particular menu items associated with the menu boxes;
display the particular menu items in the menu boxes in response to receiving user input to select the particular menu items, wherein a complete sentence in a human language is formed by the fixed text and the particular menu items; and
display graphical elements that identify media assets that satisfy criteria indicated by the complete sentence.

9. The computing device of claim 8,
wherein the graphical elements include a particular graphical element that identifies a particular media asset; and
wherein the one or more processors are further configured to offer the particular media asset for sale or rent in response to receiving user input to select the particular graphical element.

10. The computing device of claim 8, wherein the one or more processors are further configured to:
send a request to a server system, the request indicating the particular menu items; and
receive a response from the server system, the response indicating the media assets that satisfy the criteria indicated by the complete sentence.

11. The computing device of claim 8, wherein the one or more processors are further configured to modify the sentence template in response to receiving the user input to select the particular menu items.

12. The computing device of claim 8, wherein the one or more menu boxes initially display default menu items, the default menu items selected to guide users to promoted media assets.

13. The computing device of claim 8, wherein the sentence template is a first sentence template, the fixed text is a first fixed text, the one or more menu boxes are a first set of one or more menu boxes, the complete sentence is a first complete sentence, and the one or more processors are further configured to:
display a second sentence template, the second sentence template including a second fixed text and a second set of one or more menu boxes; and
display selected menu items associated with the second set of one or more menu boxes in response to receiving user input to select the selected menu items associated with the second set of one or more menu boxes, wherein the second fixed text and the selected menu items associated with the second set of one or more menu boxes form a second complete sentence in the human language, wherein the graphical elements identify media assets that satisfy the criteria indicated by the first and second complete sentences.

14. The computing device of claim 13, wherein the one or more processors are configured to determine the second sentence template based at least in part on the particular menu items associated with the first set of one or more menu boxes.

15. A method comprising:
displaying, by a computing device, a first user interface of a digital entertainment service, the first user interface including graphical elements that identify digital media assets associated with a first sub-account associated with an account;
displaying, by the computing device and in response to receiving a user input to log in a second sub-account associated with the account, a prompt to enter a passcode associated with the second sub-account; and
displaying, by the computing device and in response to receiving a user input of the passcode associated with the second sub-account, a second user interface of the digital entertainment service, the second user interface including graphical elements that identify digital media assets associated with the second sub-account.

16. The method of claim 15, further comprising displaying, by the computing device, a third user interface of the digital entertainment service, the third user interface including graphical elements that enable a user associated with the first sub-account to set restrictions on types of media assets that users associated with the first and second sub-accounts are allowed to access from the digital entertainment service.

17. The method of claim 15, further comprising:
wherein the first user interface includes graphical elements that identify a first set of one or more playlists curated by a user associated with the first sub-account; and
wherein the second user interface includes graphical elements that identify a different second set of one or more playlists curated by a user associated with the second sub-account.

18. The method of claim 15, wherein the first and second user interfaces include graphical elements that identify a set of one or more playlists shared by each sub-account associated with the account.

19. The method of claim 15, further comprising associating a first wish list with the first sub-account and a second wish list with the second sub-account.

20. The method of claim 15, further comprising adding a new digital media asset to a wish list associated with the second sub-account in response to determining that the new media asset complies with the restrictions associated with the second sub-account.
